(19) United States
(12) Patent Application Publication
(10) Pub. No.: US 2017/0183967 A1
(43) Pub. Date: Jun. 29, 2017

(54) MODULAR CONTROLLING SYSTEM FOR VENTILATION EQUIPMENT AND METHODS OF USING THE SAME

(71) Applicant: Howden Alphair Ventilating System Inc., Toronto (CA)

(72) Inventors: Michel MASSE, Toronto (CA); Jocelyn Morier, Toronto (CA)

(21) Appl. No.: 15/309,491

(22) PCT Filed: May 11, 2015
(86) PCT No.: PCT/CA2015/050425

§ 371 Date: Nov. 8, 2016

Related U.S. Application Data
(60) Provisional application No. 61/991,530, filed on May 11, 2014.
(60) Provisional application No. 61/991,531, filed on May 11, 2014.

(51) Int. Cl. E21F 1/00; G05B 19/042; H05B 37/02; E21F 17/04

(52) U.S. Cl. CPC E21F 1/00; E21F 17/04; G05B 19/042; H05B 37/0272; G05B 2219/25314

(57) ABSTRACT

A modular controlling system for controlling and/or interfacing sophisticated power, communication, monitoring, lighting, ventilation and/or other services systems in complex environments such as underground mines, pharmaceutical laboratories and production facilities and nuclear plants comprises a main processing unit, several communication interface units, several equipment interface units, and a user interface unit. The modular controlling system is configured to be installed in a complex environment such as an underground mine and connected to various mining equipment, including ventilation equipment and environmental sensors. The modular controlling system is generally preprogrammed and preconfigured with all the necessary operating programs, control algorithms and equipment drivers such as to required minimal customization upon installation.

### CROSS-REFERENCE TO RELATED APPLICATIONS

The present patent application claims the benefits of priority of commonly assigned U.S. Patent Application No. 61/991,530, entitled “MODULAR CONTROL SYSTEM FOR MINING EQUIPMENT” and filed at the UNITED STATES PATENT AND TRADEMARK OFFICE on May 11, 2014 and commonly assigned U.S. Patent Application No. 61/991,531, entitled “MODULAR CONTROL SYSTEM FOR MINING EQUIPMENT” and filed at the UNITED STATES PATENT AND TRADEMARK OFFICE on May 11, 2014 both incorporated herein by reference.

### FIELD OF THE INVENTION

The present invention generally relates to controllers and controlling systems configured for controlling and/or interfacing ventilation and other equipment and methods of using same. The present invention more particularly relates to controllers and controlling systems configured for controlling and/or interfacing ventilation equipment, sensors and other equipment in underground mines and other complex environments.

### BACKGROUND OF THE INVENTION

When an underground mine is developed and operated, an important infrastructure must be deployed underground to provide power, communication, monitoring, lighting, ventilation and/or other services to the miners and other mining personnel. Since no two mines share a common configuration, the infrastructure must be adapted for each mine.

Similar customization may be required in other complex environments having sophisticated power, communication, monitoring, lighting, ventilation and/or other services systems such as pharmaceutical laboratories or, production facilities, semiconductor research or production facilities and nuclear plants.

To control and/or interface these various services, the current approach is to design controllers and other controlling systems for the particular infrastructure configuration of the mine or other complex facility. Though this custom approach works, it remains that it has several shortcomings.

First, the current custom approach is extremely time consuming to deploy. Indeed, since all the controlling systems are custom made, they must be designed to control and/or interface the particular equipment to which they will be connected. In addition, in the case of mines, these controlling systems must then be deployed underground. Such deployment is long as the various controlling systems must then be individually connected to the particular equipment.

Second, and this is related to the first shortcoming above, the current custom approach is not scalable. In other words, the development work performed for designing controlling systems for one mine or other complex facility can rarely be reused in the design of the controlling systems of another mine or other complex facility. Similarly, if a mine grows, the additional controlling systems must also be individually designed and deployed.

Third, the current custom approach requires skilled personnel on site during deployment of the controlling systems and after for maintenance and repair. However, due to the typically remote-nature of underground mines, skilled personnel are generally scarce and deploying skilled personnel in such remote regions is usually expensive.

Fourth, due to the harsh nature of underground mine operations (e.g. heavy vehicles traveling in tight spaces), it is not uncommon for a vehicle or a machine to damage a controlling system. When such a collision occurs and the controlling system is severely damaged, it is generally necessary to repair or even replace the whole controlling system. However, since the cabinet was custom-made and custom-installed, the replacement of the damaged controlling system takes time and again the presence of skilled personnel.

Hence, in view of the foregoing, there is a need for different approach in the design and deployment of controllers and controlling systems in underground mines and other complex environments that will at least mitigate some of the shortcoming of the current custom approach.

### SUMMARY OF THE INVENTION

The shortcomings of the prior art custom approach to designing and deploying controllers and controlling systems for equipment in underground mines and other complex environments are generally mitigated by a modular controlling system which is preprogrammed and preconfigured to support a series of equipment.

In accordance with the principles of the present invention, the modular controlling system is preprogrammed and preconfigured to support a series of complex environment equipment, selected from the group of power, communication, monitoring, lighting, ventilation and/or other services systems, the system comprising a standard cabinet for providing physical and environmental protection for the electric and electronic components of the system, a main processing unit, a memory unit, communication interface units, equipment interface units and a user interface unit.

In accordance with the principles of the present invention, a method of using modular controlling system is disclosed. The method typically comprises the steps of:
a. activating the controlling system;
b. detecting all the equipment connected to the controlling system;
c. retrieving operating parameters of the equipment via the communication interface units; and
d. transmitting operating parameters to the equipment.

In accordance with the principles of the present invention the method of using modular controlling system may further comprise the steps of:
a. replacing a malfunctioning or damaged controlling system by disconnecting all cables connected to the cabinet;
b. removing or dismounting the malfunctioning or damaged controlling system from a wall;
c. mounting a new controlling system;
d. reconnecting all disconnected cables; and
e. activating the controlling system via a control system screen.

In accordance with the principles of the present invention, the modular controlling system generally comprises a standard cabinet in which are located all the various electric and electronic components of the controlling system.

The controlling system generally comprises a main processing unit generally in the form of a computer or a similar processing platform, a memory unit, several communication interface units, several equipment interface units, and a user interface unit.

In typical yet non-limitative embodiments of the modular controlling system in accordance with the principles of the present invention, the communication interface units of the controlling system comprise at least one network interface unit configured to communication with a wired or wireless network deployed in the mine or other complex environment, and at least local communication unit configured to communicate with an external device or apparatus.

In typical yet non-limitative embodiments of the modular controlling system in accordance with the principles of the present invention, the equipment interface units of the controlling system comprise at least one controlling interface unit (e.g. a relay) and at least one sensing interface unit. The at least one controlling interface unit is configured to be connected to a controllable mining equipment such as a fan or a damper. For its part, the at least one sensing interface unit is configured to be connected to a local or remote sensor in order to collect environmental data of the underground mine or other complex environment.

The user interface unit is generally configured to allow an operator or other personnel to enter operating parameters for one or more equipment and/or to retrieve data from the controlling system (e.g. operating status, environment data, error codes, etc.).

In accordance with the principles of the present invention, the main processing unit and/or the memory unit are preloaded with all the operating programs and control algorithms and with all the equipment drivers necessary for the controlling system to control, interface and/or otherwise communicate with the various equipment deployed in the mine or other complex environment and to which the controlling system can be connected. In that sense, the processing unit will generally automatically detect to which equipment the controlling and sensing interface units are connected.

In addition, in accordance with the principles of the present invention, all the units comprised in the controlling system and located in its cabinet are generally standard and thus swappable for a replacement unit in case, for instance, of a unit malfunction.

By using a modular and standardized approach to control various equipment, the modular controlling system in accordance with the principles of the present invention generally mitigates several shortcomings of the prior art custom approach. For instance, since all the controlling systems are substantially identical, they can be quickly deployed during installation and they can be quickly replaced in case of accident or malfunction. In addition, since the controlling systems are already preprogrammed and preconfigured to control and/or interface a series of mining equipment, the installation of controlling systems does not require skilled personnel during deployment and for maintenance.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a front view of an embodiment of a controlling system in accordance with the principles of the present invention.

FIG. 2 is a right side view of the controlling system of FIG. 1.

FIG. 3 is a left side view of the controlling system of FIG. 1.

FIG. 4 is a schematic view of the components of the controlling system of FIG. 1.

FIG. 5 is a schematic view of the controlling system of FIG. 1 in relation with the infrastructure of an underground mine.

FIGS. 6A to 6C are front views of embodiments of extension plates in accordance with the principles of the present invention

FIG. 7 is a schematic view of an exemplary installation of an embodiment of a controlling system in accordance with the principle of the present invention.

FIG. 8 is a schematic view of an exemplary installation of an embodiment of a controlling system with Variable Frequency Drives.

### DETAILED DESCRIPTION OF THE PREFERRED EMBODIMENT

A novel modular controlling system for mining and other equipment will be described hereinafter. Although the invention is described in terms of specific illustrative embodiments, it is to be understood that the embodiments described herein are by way of example only and that the scope of the invention is not intended to be limited thereby.

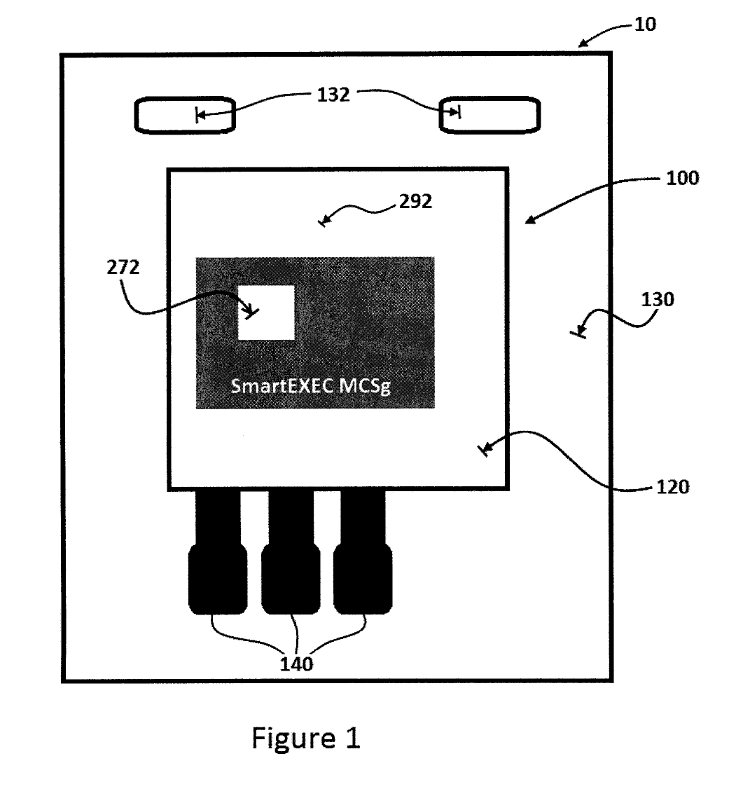

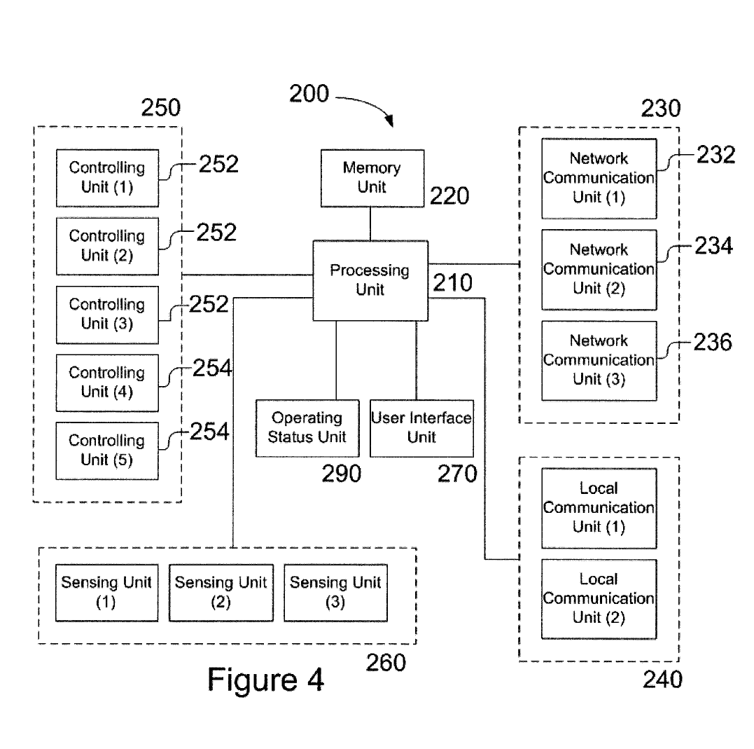

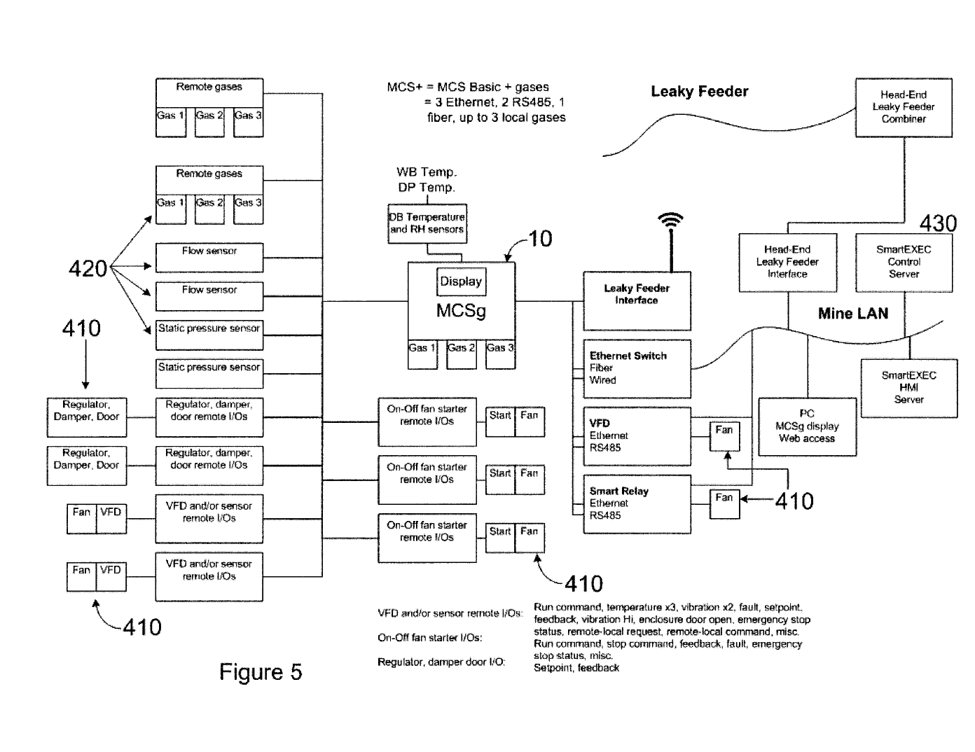

Referring first to FIGS. 1 to 3, an embodiment of a modular controlling system is shown at 10. The controlling system 10 comprises a cabinet 100 that provides physical and environmental protection for the components 200 (see FIG. 4) of the system 10. The modular controlling system 10 is generally configured to be deployed in an underground mine or other complex environment and connected to various equipment such as fans, dampers, regulators, sensors, etc. 410 and 420 (see FIG. 5) to control and/or interface these equipment. The modular controlling system 10 is also generally configured to be connected to a wired or wireless communication network deployed in the mine or other complex environment to receive new or updated control instructions and/or operating parameters from the main controller 430 of the operation center (not shown) and to transmit equipment operation data and environmental data back to the main controller 430 (see FIG. 5).

The cabinet 100 generally comprises an enclosure 110 and an access door 120 and peripheral connections to equipment and/or sensors mounted thereto. In the present embodiment, the cabinet 100 is generally made of metallic material (e.g.

stainless steel) such as to sustain the harsh environment of an underground mine or other complex environment. In that sense, when closed, the door 120 generally forms a tight seal with the enclosure 110 to prevent dust or other contaminants from entering the cabinet 100. The provided tight seal is of NEMA4 type.

As shown in FIGS. 1 to 3, the cabinet 100 is further mounted to a mounting plate 130 comprising one or more mounting openings 132. In the present embodiment, the mounting plate 130 is made of metallic material (e.g. aluminum). This mounting plate 130 allows the cabinet 100 to be easily mounted to the wall of a tunnel in a mine or other appropriate location using standard fasteners (e.g. hooks, screws, bolts, carabiners, tie-wraps, etc.). In that sense, in underground mines, the walls of the tunnels are often covered with metallic mesh (anchored with rock bolts) to prevent rocks from falling. The mounting plate 130 can thus be easily mounted to such mesh.

Referring now to FIG. 4, the components of the controlling system 10 are schematically shown at 200.

The components 200 of the controlling system 10 generally comprises a main processing unit 210 and one or more memory unit 220 connected thereto, several communication interface units 230 and 240, several equipment interface units 250 and 260, and a user interface unit 270.

In the present embodiment, the main processing unit 210 is generally embodied as a computer or as a similar processing platform. In other embodiments, the main processing unit 210 could be embodied as a micro-controller, a programmable integrated circuit (e.g. PLC), or as a custom integrated circuit (e.g. ASIC).

In the present embodiment, the main processing unit 210 and/or the memory unit 220 are preloaded with all the necessary operating programs, control algorithms and equipment drivers (i.e. an interfacing program to communicate with a particular equipment) such that the controlling system 10 requires minimal or no customization upon installation. If necessary, these operating programs, control algorithms and equipment drivers can be locally or remotely updated.

The controlling system 10 comprises two types of communication interface units, network interface units 230 and local communication unit 240.

The network interface units 230 are configured to communicate with various types of networks that can be deployed in the underground mine or other complex environment. For instance, the network interface units 230 could comprise a wireless network interface unit 232 (e.g. a leaky feeder network), an optical network interface unit 234 (e.g. an Ethernet fiber optic network), a wired network interface unit 236 (e.g. an Ethernet network), etc. Though the controlling system 10 could comprise more or less network interface units 230, in the present embodiment, the controlling system 10 comprises a network interface unit 230 for each of the most commonly deployed networks in underground mines or other complex environment. Notably, the modular controlling system 10 is generally generic enough to be deployed with limited or no customization.

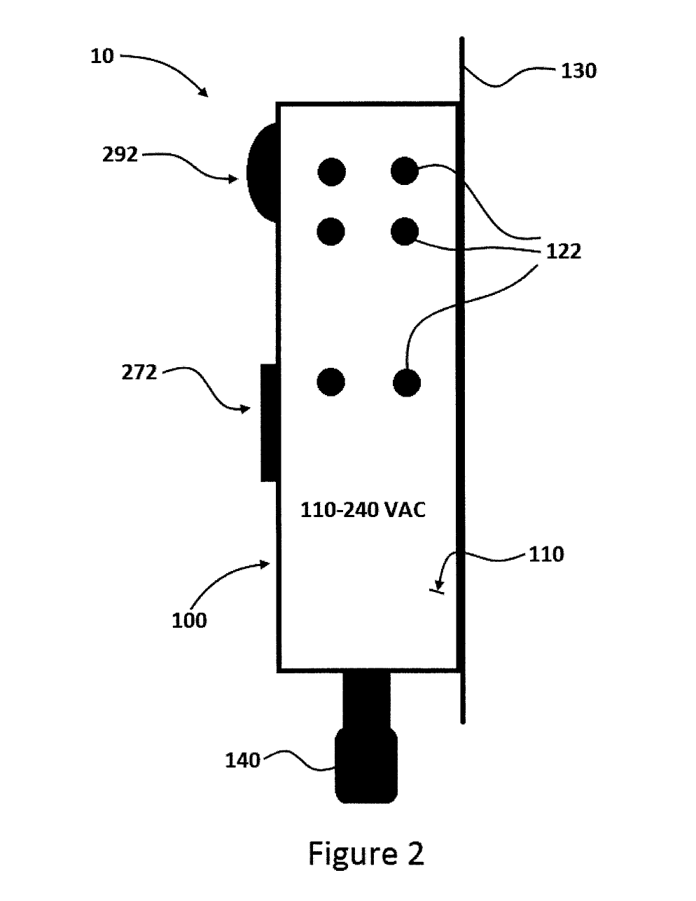

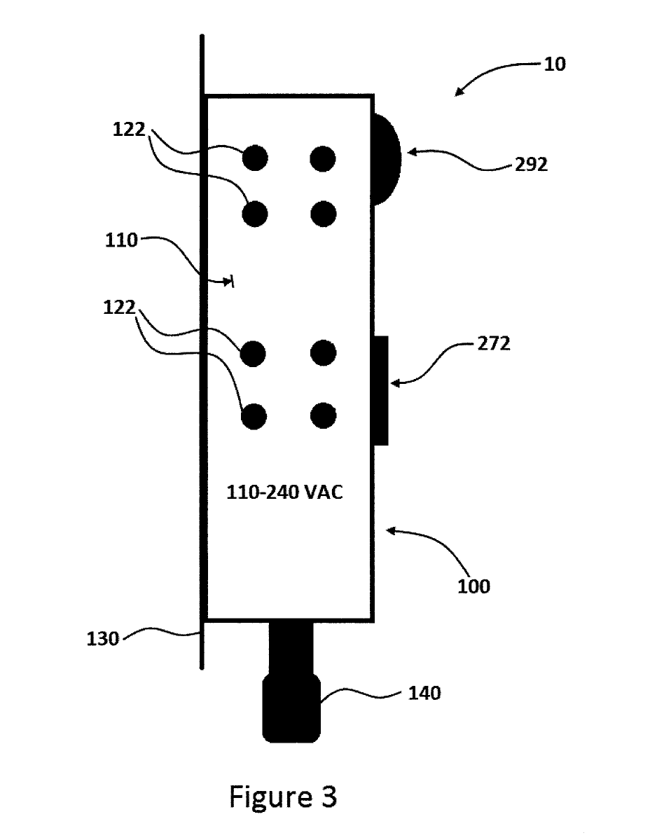

Understandably, depending on the network interface units 230 comprised in the controlling system 10, the enclosure 120 of the cabinet 100 of the controlling system 10 would comprise the necessary port(s) 122 (see FIGS. 2 and 3) to receive cables or antennas to allow the controlling system 10 to be properly connected to the network(s) deployed in the mine or other complex environment.

For their part, the local communication interface units 240 are generally configured to communicate with devices and/or apparatuses located relatively near the controlling system.

In the present embodiment, the local communication interface units 240 comprise at least one RS-485 communication interface.

The RS-485 communication interface permits data interchange to other intelligent local control devices such as smart relays for motor starters and variable frequency drives for fan motors.

Similar to the communication interface units, the equipment interface units also comprise two types of interface units, controlling interface units 250 and sensing interface units 260.

The controlling interface units 250 are configured to control the equipment to which they are connected. In the present embodiment, the equipment are more particularly ventilation equipment such as, but not limited to, fans (on-off and variable), dampers, airflow regulators, doors, etc.

To maintain the modularity of the controlling system 10, the number of different controlling interface units 250 is generally limited. For instance, a controlling system 10 could comprise three controlling interface units 252 configured to provide on-off control (e.g. to control on-off fans), and two controlling interfacing units 254 configured to provide modulated control (e.g. to control variable-frequency drive fans, adjustable regulators, etc.) (see also FIG. 5).

The sensing interface units 260 are configured to be connected to various sensors deployed in the mine or other complex environment (see also FIG. 5).

Due to the confined nature of underground mines, ventilation is an important, if not critical aspect, of underground mine operation. The same is also true in or other complex environments such as pharmaceutical and nuclear environments. In the present embodiment, and as indicated above, the controlling interface units 250 are particularly configured to be connected to ventilation equipment. Similarly, in the present embodiment, the sensing interface units 260 are particularly configured to be connected to environmental sensors such as, but not limited to, temperature sensor(s), humidity sensor(s), gas sensor(s), air flow measurement station(s), fan static pressure sensor(s), etc.

Understandably, by allowing the controlling system 10 to be connected to several environmental sensors, the controlling system 10 can collect and transmit these environmental data back to the main controller 430 of the operation center where ventilation adjustments can be perform to maintain the proper level of ventilation in the mine or other complex environment.

In the present embodiment, as shown in FIGS. 1 to 3, some of the gas sensors 140 to which the sensing interface units 260 can be connected are directly yet removably mountable to the cabinet 100 and more particularly to the enclosure 120. By being removable, the gas sensors 140 can be easily removed and replaced by the same or another gas sensor 140.

In the present embodiment, most of the components 200 are removably mounted within the cabinet 100. Consequently, a defective or damaged unit can be removed and replaced by another unit. Since all the controlling systems 10 are essentially identical, only a small inventory of replacement units need to be maintained for all the controlling systems 10.

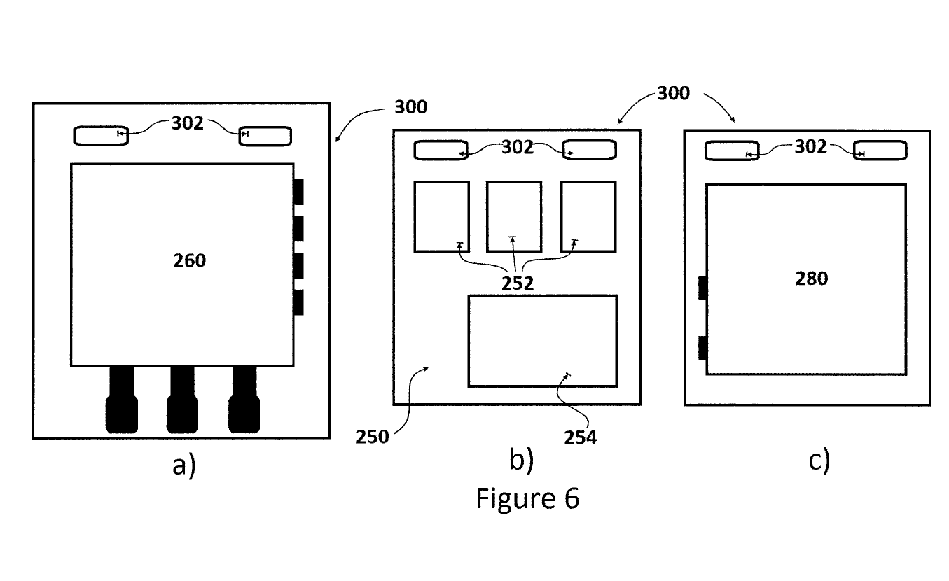

Understandably, to maintain the modularity and relative standardization of the controlling system 10, the equipment to which the controlling system 10 is connected may be remotely connected. Therefore, for additional equipment that need to be controlled or interfaced, it could be wasteful to install yet another controlling system 10 for just these additional equipment. To minimize such wasteful installation, the controlling system 10 can be connected to a network extension plate 300. This extension plate 300 is generally configured to receive additional controlling interface units 250 (see FIG. 6B), additional sensing interface units 260 (see FIG. 6A), and/or additional power supply units 280 (see FIG. 6C). Understandably, these additional controlling interface units 250, additional interface units 260, and/or additional power supply units 280 can be used control, interface and/or power additional equipment without the need for a complete controlling system 10.

In the present embodiment, the extension plate 300 is made of metallic material (e.g. aluminum) and comprises, as the mounting plate 130, mounting openings 302. Also, the extension plate 300 is generally provided with a predetermined array of fastener received openings (not shown) configured to receive the additional controlling interface units 250, additional interface units 260, and/or additional power supply units 280.

Referring back to FIG. 1, as mentioned above, the controlling system 10 also comprises a user interface unit 270. In the present embodiment, this user interface unit 270 is a screen 272 (e.g. a touch screen) located on the outer side of the door 120 such as to be easily accessible to operators and other mine personnel.

In the present embodiment, the screen 272 of the user interface unit 270 allows operators and other personnel to modify the operating parameters of one or more controllable equipment and/or to retrieve operating data of the various equipment connected to the controlling system 10 and environmental data captured by the various sensors connected to the controlling system 10. During normal operation of the controlling system 10, the screen 272 will generally display up-to-date equipment operating data and relevant environmental data (e.g. levels of toxic gases) such as to be easily accessible to every personnel for quick review.

As can be seen in FIGS. 1 and 4, the controlling system 10 also comprises an operating status unit 290 that comprises one or more color-coded lights. In the present embodiment, the operating status unit 290 comprises one light 292 capable of generating three different colors, i.e. green, yellow and red. Understandably, in other embodiments, the numbers of lights, the number of colors and/or the choice of colors could be different.

As shown in FIG. 1, in the present embodiment, the light 292 is located on the door 120 such as to be easily visible by personnel located in the vicinity of the controlling system 10. The light 292, which is connected to the main processing unit 210, will generate a different color, continuously or according to a predetermined flashing sequence, to indicate the operating status of the controlling system 10 itself or of any equipment connected thereto. Understandably, when the light 292 indicates that a problem has been detected within the controlling system 10 or with any of the equipment, additional information about the diagnosed problem could be displayed on the screen 272 of the user interface unit 270.

Even though the combination of colors and flashing sequences of the light 292 could be as complex as desired to indicate various operating statuses of the controlling system 10 and of the equipment connected thereto, it is generally advantageous to keep to combination of colors and flashing sequences to a small number. For instance, in the present embodiment, the processing unit 210 is programmed to control the light 292 such as to display four combinations of colors and flashing sequence indicative of four operating statuses.

When the controlling system 10 and all the equipment connected to it are operating normally, the light 292 generates a continuous green light. When at least one measurement (e.g. an equipment operating data or an environmental data) is outside a predetermined range, the light 292 will generates a continuous yellow light. When a fan is operating in its high pressure fan curve zone, the light 292 will generates a flashing yellow light. Finally, when there is a system problem, the light 292 will generates a continuous red light.

In use, several controlling systems 10 will be deployed and installed throughout an underground mine or other complex environment and connected to the various equipment they need to control (e.g. fans, dampers, etc.) and/or interface (e.g. sensors). The controlling systems 10 will themselves be connected to the main controller 430 of the mine or other complex environment operation center, via either a wired network (e.g. optical network, Ethernet network, etc.) or a wireless network (e.g. leaky feeder network) deployed throughout the mine or other complex environment.

Via their connection to the main controller 430 of the operation center, the various controlling systems 10 will receive operating parameters for the various controllable equipment under their respective control. Also, the controlling systems 10 will forward operating data and environmental data to the main controller 430 of the operation center such that the main controller 430 of the can update or adjust the operating parameters of each of the controllable equipment. The operating data and environmental data transmitted by the controlling systems 10 can also be reviewed by the personnel at the operation center to determine the general operational and environmental status of the mine or other complex environment.

Understandably, since all the controlling systems 10 are substantially identical, should one controlling system 10 be damaged, for instance, by a passing vehicle, the replacement of the damaged controlling system 10 can be done relatively quickly and easily by mine personnel.

To replace a malfunctioning or damaged controlling system 10, the personnel only needs to disconnect all the cables connected to the cabinet 100 and, if any, all the gas sensors 140, remove or dismount the malfunctioning or damaged controlling system 10 from the wall (or other mounting location), mount the new controlling system 10, reconnect all the cables and, if any, the gas sensors 140, and activate the controlling system 10 via the screen 272.

Upon activating the controlling system 10, the processing unit 210 will detect all the equipment connected to the controlling system 10, retrieve the operating parameters of the controllable mine equipment from the main controller 430 of the operation center (via the network), and transmit the operating parameters to the controllable equipment.

By being modular and substantially identical, the controlling system 10 in accordance with the principles of the present invention generally mitigates several shortcomings of the prior art custom approach. For instance, since all the controlling systems 10 are substantially identical, that is preconfigured and preloaded to control and interface the same equipment, the controlling systems 10 can be easily and quickly deployed in an underground mine or other complex environment, the deployment of the controlling systems 10 can be scaled (adding controlling systems 10 is relatively simple), the deployment of the controlling systems 10 can be done by less skilled personnel, and each one of the controlling systems 10 can be easily and quickly replace in case of malfunction or accident.

According to an embodiment, the controlling system 10 is preprogrammed. The controlling system is ready for real-time control and optimization in a mine. All that is required for a specific use is parameterization of the controlling system as described hereunder. The controlling system interfaces with existing infrastructure using Open Connectivity (OPC). This control technology is integrated into ventilation design connecting directly to Programmable Logic Controllers (PLCs), Variable Frequency Drives (VFDs), actuators, starters and other controllable devises via existing communication structures. Once communication is established, the controlling system maintains all control information for a given piece of equipment regardless of location. According to one embodiment, the controlling system also provides fail safe setpoints to the PLCs. Using dynamic linking, as ventilation equipment is added or removed, altering the process control is a configuration change executed by the ventilation personnel. The changes require no programming for controls or human machine interfaces.

According to one embodiment, the controlling system is preprogrammed to allow several control levels. For instance, first level control comprise manual and ratio controls actuated through input parameters. Second level control comprise event and scheduling control. Third level controls comprise flow and gas concentration control using setpoint input by an operator of using specific event in a control schedule. The fourth level is a flow control as a function of dynamic tracking (VOD) with gas concentration control. Additionally, the controlling system may comprise a fifth level comprising optimization and advanced controls such as complex environment air flow distribution, surface fan speed and total mass flow control.

According to an exemplary embodiment, the controlling system is preprogrammed to allow parameter configuration entry through HMI to define monitoring, controls and options. In the preferred embodiment, no control programming is required for utilization, all controls are pre-programmed. Likewise, no HMI programming is required by the user, all HMI functionality is pre-programmed. Access to the HMI may be via wires, fibers or Wifi. Each controlling device should in each model comprise the same code for all and independent of the application configuration and options of the controlling system. Also, the controlling system allows automatic code upgrade via USB key connection to PLC.

According to one embodiment, the controlling system is a rapid deployment and installation with pre-wired connection. Various communication options such as Wired Ethernet, fiber Ethernet, Wifi and Leaky Feeder, Interface to controlling surface software. Modbus RTU (RS-485) or TCP interface to controlling system or, third party Scada or PLC systems may also be available to the user.

According to one embodiment, the controlling system allows monitoring and control with no programming required for control or display interface. In a typical embodiment, only a configuration process via the user interface is required. As such, the configuration of the system may typically be achieved solely by the input of parameter values through the user interface. The controlling system measures temperature, humidity and velocity-flow. The controlling system may accept up to two velocity-flow measurements from other controlling or monitoring units with the 4-20 mA input connectors. The sensors may also be provided separately. As such, the controlling system may accept up to two fan static pressure measurements with the 4-20 mA input connectors. Additionally, the controlling system may measure up to three gases locally on the unit. Additional remote gas measurements are also possible through additional connections. The controlling system may be complemented by numerous additions for remote I/Os and additional remote enclosures for gas sensing. Likewise, in the preferred embodiment, no field wire termination is required for sensors and controls. The sensors and controls interface to the controlling system with a cable and connector to the unit. The unit may also be Ethernet ready with Modbus-TCP communication capability. The user of the controlling system may interact with the unit via a color touchscreen or via web access through Ethernet. Each controlling system may comprise CANopen (M12 connectors), 24 VDC (M8 connectors) and signal cables (M8 connectors) which are pre-fabricated at specified length with connectors on both ends. Signal cables may also be pre-fabricated at specified length with M8 connectors at both ends.

According to one embodiment, the controlling system may have pre-programmed VFD, damper, door and regulator controls and related HMIs. Accordingly, the control system could allow manual control, [0-100]% speed or opening, setpoint by operator, schedule or preprogrammed speeds low, medium and high. Other control function comprise timer control, scheduling (i.e. 10 changes per day, per controller, mode and setpoint) and flow and gas control such as flow setpoint by operator or schedule. Such control functions are further integrated with high alarm and high high alarm with configurable action on vibration, fan motor temperature, fan stall detection. The controlling system may according to one embodiment control up to 9 gases. Fan start or regulator control may also be actioned by motion detection.

According to one embodiment, the controlling system may have On-Off fan controls and related HMIs. Accordingly, the control system could allow manual control, “start-stop”, setpoint by operator or schedule”, time control, scheduling (i.e. 10 changes per day per controller) further integrated with high alarm and high high alarm with configurable action on vibration, fan motor temperature, fan stall detection and gas threshold starting fan.

According to an exemplary embodiment, the communication of the controlling system could be via:
Three wired Ethernet ports on station (LAN connection or Modbus TCP protocol to PLC or SCADA)
Optional Fiber optic Ethernet connection
Two RS-485 ports (Modbus RTU protocol)
4-20 mA output for speed or flow measurement
Leaky Feeder option
Controlling system surface software connection option

According to an exemplary embodiment, the measurements connected to the controlling system could be:
Dry bulb temperature
Relative humidity
Calculated wet bulb temperature
Calculated dew point temperature
Two velocity-flow sensor connections (sensors optional)
   i. Vortex type
   ii. “Time of flight” type
   iii. Third party air velocity-flow sensors
Two fan static pressure sensor connections (sensors optional)
Optional gas measurement at controlling system's location (up to 3 sensors)

According to an exemplary embodiment, the remote I/O options could comprise:
Remote gas measurement using a remote enclosure (up to
Remote I/O module for regulator, damper or door control (up to 2)
Remote I/O module for On-Off starter (up to 3)
Remote fan analog and digital I/O module (up to 2)

According to an embodiment, the installation of the system is achieved with little technological knowledge. The system components are secured to walls or mounted on building supports of a complex environment using fasteners. The components are then connected using preidentified and premeasured wires with identification on both ends. Connections on the components are also identified with the same identification code as the wire connectors, simplifying the connection of the system as a whole. Stated otherwise, the installer generally only requires basic skills without electrical or computer skills. The components and wires are shown in a plan predisposed for installation in the complex environment to allow operators mounting of the controlling system in a “plug and play” manner. Connectors will only be complementary with their designated connector on the controlling system cabinet, thus minimizing the likelihood of misconnections. Once all components, modules and sensors are interconnected (wired or not), the operator input the required parameter on the controlling system display panel. Alternatively, the parameters may be communicated remotely through the network by using the controlling system cabinet main IP address. During operation of the controlling system, parameters may be altered or maintained using either manual, scheduling or remote control. Additionally, the controlling system may comprise one or more billboard for displaying information to the workers. The billboard may also be used to display emergency messages.

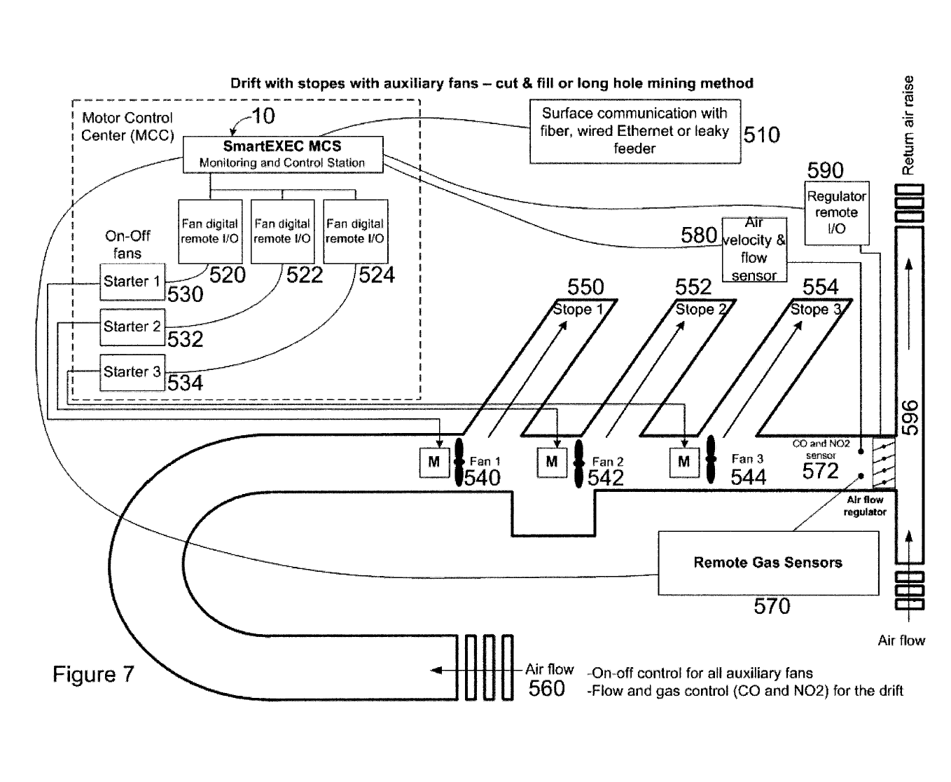

Now referring to FIG. 7, a schematic view of an exemplary installation of an embodiment of a controlling system in accordance with the principle of the present invention is shown. The controlling system 10 is connected to fan digital remote I/O 520, 522, 524 in connection with On-Off fans starter 530, 532, 534. The fans starter 530, 532, 534 are respectively connected to fans 540, 542, 544 located inside the drift section. the fans 540, 542, 544 direct air flow (560 to 569) to their respective slope 550, 552, 554 depending on the input parameters, entered in the controlling system 10 and the various reading of the sensors 572 connected to gas remote component 570 itself in connection (wired or not) with the controlling system 10. In addition to the gas sensors 572, the air velocity and flow sensor 580 is also used in the parameter for determining the level of activity of the fan 540, 542, 544 required to maintain the desired level. The controlling system 10 is also operatively connected to a remote regulator 590 controlling the air flow in the drift. Moreover, the controlling system 10 is connected to a surface communication device 510 linking the control center of the complex installation with the controlling system 10. This connection may be wired Ethernet, fiber, or leaky feeder.

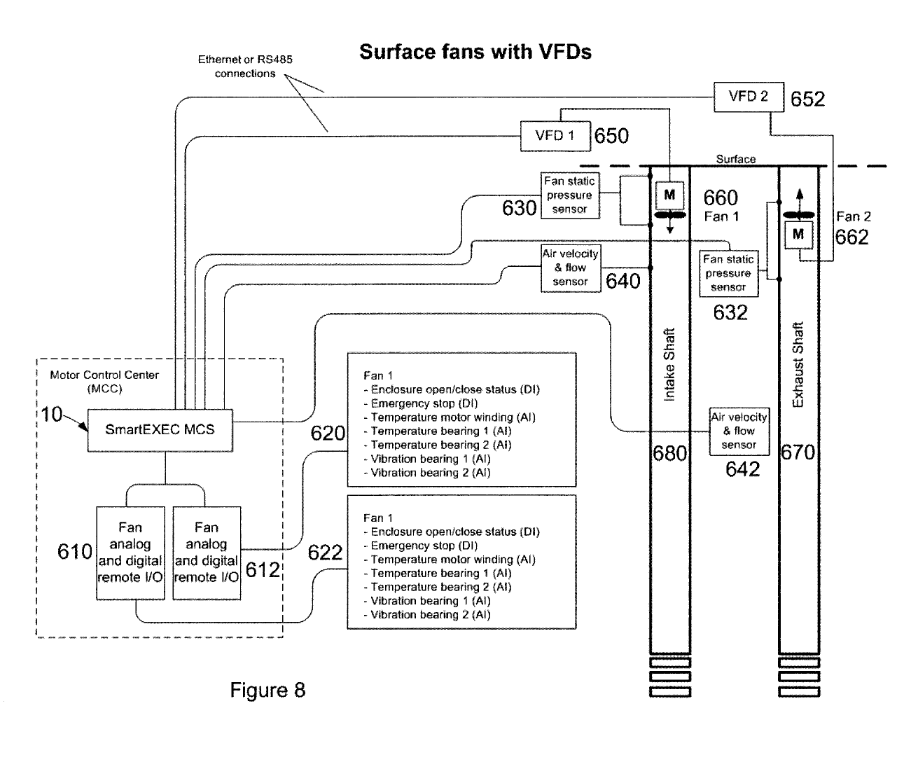

Now referring to FIG. 8, is shown a schematic view of an exemplary installation of an embodiment of a controlling system with Variable Frequency Drives (VFD) is disclosed. The controlling system 10 is connected to fan analog digital remote I/O 610, 612 each connected to a fan 620, 622. The controlling system 10 is operatively connected to VFDs 650, 652 connected to fans 1 660, 662 respectively located in intake shaft 680 and exhaust shaft 670. The VFDs 650 and 652 are actuated using the input parameter in the control system and the monitored values of the air velocity and flow sensors 640, 642 respectively located in intake shaft 680 and exhaust shaft 670 and fan static pressure sensor 630, 632 also respectively located in intake shaft 680 and exhaust shaft 670 and operatively connected to the controlling system 10.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A modular controlling system preprogrammed and preconfigured to support a series of complex environment equipment, selected from the group of power, communication, monitoring, lighting, ventilation and/or other services systems the system comprising:
a) a standard cabinet for providing physical and environmental protection for the electric and electronic components of the system;
b) a main processing unit;
c) a memory unit;
d) communication interface units;
e) equipment interface units; and
f) a user interface unit.

2. The modular controlling system of claim 1, wherein the complex environment is selected from the group of underground mines, pharmaceutical laboratories, pharmaceutical production facilities, semiconductor production plants, semiconductor research facilities or nuclear plants.

3-5. (canceled)

6. The modular controlling system of claim 1, wherein the at least one local communication unit is configured to communicate to an external device or apparatus.

7. The modular controlling system of claim 1, wherein the equipment interface units comprise at least one controlling interface unit.

8. The modular controlling system of claim wherein the at least one controlling interface unit is a relay.

9. The modular controlling system of claim 7, wherein the at least one controlling interface unit is configured to be connected to a controllable equipment.

10. The modular controlling system of claim 7, wherein the controllable equipment is a fan or a damper.

11. The modular controlling system of claim 1, wherein the equipment interface units comprise at least one sensing interface unit.

12. The modular controlling system of claim 11, wherein the at least one sensing interface unit is configured to be connected to a local or remote sensor to collect environmental data of the complex environment.

13. The modular controlling system of claim 1, wherein the user interface unit is configured to allow an operator to enter operating parameters for one or more equipment and/or to retrieve data from the controlling system.

14. The modular controlling system of claim 1, wherein at least one of the main processing unit or the memory unit is preloaded with operating programs and control algorithms and with all equipment drivers necessary for the controlling system to control, interface and/or otherwise communicate with the various mining equipment deployed in the complex environment and to which the controlling system can be connected.

15. The modular controlling system of claim 1, wherein the processing unit automatically detect to which equipment the controlling and sensing interface units are connected.

16. (canceled)

17. The modular controlling system of claim 1, wherein the various equipment are selected from the group consisting of fans, dampers, regulators, sensors to control and interfaces for the equipment.

18-33. (canceled)

34. The modular controlling system of claim 1, wherein the system further comprise three controlling interface units configured to provide on-off control, and two controlling interfacing units configured to provide modulated control

35. The modular controlling system of claim 34, wherein the two controlling interfacing units are configured to control variable-frequency drive fans or adjustable regulators.

36. (canceled)

37. A method of using modular controlling system of claim 1, the method comprising the steps of:
a) activating the controlling system;
b) detecting all the equipment connected to the controlling system;
c) entering the operating parameters of the equipment via the communication interface units; and
d) transmitting operating parameters to the equipment.

38. A method of using the modular controlling system of claim 37, wherein the operating parameters of the equipment are uploaded from a remotely located server.

39. A method of using the modular controlling system of claim 37, the method further comprising the step of:
a) replacing a malfunctioning or damaged controlling system by disconnecting all cables connected to the cabinet;
b) removing or dismounting the malfunctioning or damaged controlling system from a wall;
c) mounting a new controlling system;
d) reconnecting all disconnected cables; and
e) activating the controlling system via a control system screen.

40. A method of using the modular controlling system of claim 39, the method further comprising the steps of:
a) disconnecting all the gas sensors; and
b) reconnecting all disconnected the gas sensors.
